(19) United States
(12) Patent Application Publication
(10) Pub. No.: US 2026/0048591 A1
(43) Pub. Date: Feb. 19, 2026

(54) AUTOMATED SYSTEM FOR CREATING HIGH-RESOLUTION COLORED IMAGES ON STONE

(71) Applicants: George Martin Arnold, Greer, SC (US); Timothy Scott Bronleewe, Warren, OR (US); Viet Le, Garden Grove, CA (US)

(72) Inventors: George Martin Arnold, Greer, SC (US); Timothy Scott Bronleewe, Warren, OR (US); Viet Le, Garden Grove, CA (US)

(21) Appl. No.: 19/265,547

(22) Filed: Jul. 10, 2025

Related U.S. Application Data
(60) Provisional application No. 63/669,919, filed on Jul. 11, 2024.

(51) Int. Cl. B41J 3/407; B08B 1/12; B08B 5/02; B23K 26/354; B41J 2/21; B41J 3/28; B41J 11/00; B41J 11/06; B41J 25/00; B41J 25/308; B41J 29/02; B41J 29/17; B41M 5/00; B41M 7/00; C04B 41/00; C04B 41/45; C04B 41/49; C04B 41/52; C04B 41/63; C04B 41/71; C09D 11/101; C09D 11/102; C09D 11/40

(52) U.S. Cl. CPC B41J 3/407; B08B 1/12; B08B 5/02; B23K 26/354; B41J 2/2117; B41J 3/28; B41J 11/00214; B41J 11/008; B41J 11/06; B41J 25/001; B41J 25/308; B41J 29/02; B41J 29/17; B41M 5/0047; B41M 5/007; B41M 7/0036; B41M 7/0081; C04B 41/0036; C04B 41/4572; C04B 41/4905; C04B 41/52; C04B 41/63; C04B 41/71; C09D 11/101; C09D 11/102; C09D 11/40

(57) ABSTRACT

An automated stone imaging system and method for producing high-resolution, full-color, and durable images on stone substrates such as granite, marble, and concrete. The system integrates a laser capable of vitrifying the stone surface, a UV print head for applying ink, a UV curing array, and a high-pressure air supply, all operatively controlled by a computing device within a single housing. The laser creates a textured surface for ink adhesion, the air stream removes particulate residue, and the printer deposits UV-curable inks followed by a protective clear coat. The process reduces production time, improves image longevity, and eliminates toxic materials and volatile solvents, offering enhanced safety, environmental performance, and efficiency over traditional stone imaging techniques.

### CROSS-REFERENCE TO RELATED APPLICATIONS

This application claims the benefit of priority under 35 U.S.C. § 119(e) to U.S. Provisional Patent Application No. 63/669,919 , filed on Jul. 11, 2024, the entire contents of which are hereby incorporated by reference.

### BACKGROUND OF THE INVENTION

The present invention relates to an automated system and method for producing high-resolution colored images on stone substrates, such as granite, marble, and concrete, significantly enhancing the durability and longevity of the images.

### Traditional Techniques

Traditionally, images were placed on stone—typically headstones in cemeteries—using a hand-etching tool. This method required the use of polished black stone exclusively, as it relied on the contrast between the etched area and the polished surface to reveal the image. Grayscale imaging could not be achieved with this technique. Color was manually applied but had only limited longevity, typically fading within a few years due to the pigment sitting on the surface of the stone. The quality and resolution of the etched image depended heavily on the skill of the individual engraver.

### Limitations of Laser Methods

Modern methods improved upon this process by incorporating laser engraving. A laser ablates or etches the polished surface to create lighter-colored pits on black stone. When these pits are closely aligned with sufficient density, they collectively form a monochromatic image. However, lighter-colored stones lack sufficient natural contrast, rendering this approach ineffective unless a pigment is introduced into the etched pits. Even then, once excess pigment is removed, the remaining pigment lacks permanence and degrades under environmental conditions such as sunlight, oxygen, moisture, and acids—typically within 4-5 years. Additionally, many types of stone have a natural “speckle” or grain pattern, which competes visually with the image, reducing clarity and consistency.

### Limitations of Existing Image Transfer Techniques

Various methods have been developed for applying images on different types of stone and hard substrates, often involving laser engraving, pigment application, or protective coatings. However, many of these methods lack full automation, long-term durability, or broad material compatibility. The following patents represent examples of such prior art, each of which is hereby incorporated by reference in its entirety:

### U.S. Pat. No. 7,919,191-Pigmented Images on Stone

Describes a method for creating a pigmented image on a monument stone substrate using laser engraving through a mask, followed by pigment application, curing, and protective coatings. While the pigment is embedded in the stone, the process lacks automation and has limited flexibility across varying stone compositions.

### U.S. Patent Publication No. 2011/0311779—Method for Marking a Coated Substrate

Relates to marking coated cementitious substrates by forming indicia beneath a surface coating. While suitable for concrete-based products, the method does not address long-term durability in outdoor environments or colored imaging.

### U.S. Pat. No. 8,585,956—Systems and Methods for Laser Marking Work Pieces

Discloses a method for laser marking based on grayscale pattern modulation, enabling both surface and depth engraving. However, this technique remains limited to monochrome output and does not incorporate full-color pigment or protective finishes.

### U.S. Pat. No. 9,168,760—Method of Creating an Image on a Stone Substrate Surface and Resulting Product

Describes digitally etching painted stone substrates or contrasting color coatings to create an image. It includes techniques for pigment compatibility with the stone's mineral content but lacks integrated curing or multi-step automation.

### U.S. Pat. No. 10,654,127—Engraving System and Method of Operation Thereof

Covers a laser engraving system with a three-point suspension for surface leveling and precision. While it improves accuracy, it does not provide color imaging or automated printing and curing.

### U.S. Pat. No. 11,446,761—Engraving Machine

Describes a laser engraving machine with a vibration-reducing counterweight and integrated housing structure. It is optimized for structural stability during engraving but remains monochromatic and does not address pigment application or coating.

### Need in the Art

Despite the advancements represented by these disclosures, existing methods are constrained by material compatibility, image permanence, and lack of automation. Color images applied to stone using prior techniques often fade quickly, lack resolution, or require labor-intensive manual steps. Furthermore, most methods are limited to use on black or polished stones and cannot produce consistent results on light-colored or naturally textured surfaces.

Accordingly, there remains a need for a fully automated system capable of applying high-resolution, full-color images to stone substrates of various colors and textures, using a process that ensures long-term durability and environmental resistance. The present invention addresses these needs by integrating laser vitrification, UV ink printing, and optional protective coating application into a single, programmable machine that consistently produces remarkably clear and long-lasting images.

### SUMMARY OF THE INVENTION

The present invention provides an improved method and apparatus for engraving images on granite, marble, synthetic stone, and other hard substrates. The system utilizes a precisely guided laser beam to carry out the engraving process. An automated stone imaging system is disclosed, which employs a high-power laser beam, together with a beam-steering mechanism, to engrave lettering and graphical images with exceptional realism and aesthetic quality.

The automated stone imaging system executes a process for creating colorful and durable images on stone substrates by integrating a UV wide-array printer assembly, a laser capable of vitrifying the stone surface, and a high-pressure air stream, all within a fully integrated machine. This configuration allows for complete automation within a compact footprint, significantly enhancing image resolution and production efficiency while reducing costs and environmental impact.

In a preferred embodiment, the automated stone imaging system includes a housing that contains the following operatively connected components: a laser etching system, a UV print head assembly, a computing device, a blower or air compressor for directing high-pressure air, and a UV light array for ink curing. These components are mounted on a gantry system that moves in a coordinated manner along orthogonal X and Y axes, guided by a square-profile linear rail system. The gantry is driven by one or more electric motors using a chain-and-sprocket mechanism for accurate and reliable positioning. A flexible cable drag chain is connected to the gantry to manage and protect power and signal cables as the gantry moves.

A raised platform beneath the gantry supports one or more stone substrates during processing. The system may operate on multiple substrates sequentially within a single job run. In certain embodiments, the gantry or individual tools may be adjustable along a Z-axis to accommodate varying substrate heights or optimize focal distance and ink deposition.

The process executed by the system includes several distinct steps. First, a stone or other substrate is loaded into the machine. The substrate is masked and aligned within the housing to establish the optimal focal distance for processing. A graphic file is then loaded into the computing device, where it is placed into a job queue and converted into machine-executable language capable of directing both the laser and printing operations.

The machine next employs the laser to selectively ablate or burn through the masking material, vitrifying the surface of the stone and creating a textured region (“tooth”) for ink adhesion. Upon completion of the laser vitrification step, a blower or air compressor directs a stream of high-pressure air across the lasered region to remove dust and residue, thereby preparing the surface for printing. Multiple passes may be performed to ensure thorough particulate removal.

Following the cleaning step, the UV printer head applies colored UV inks to the treated surface. These inks are instantly cured by an integrated UV array. Once the image is printed, a UV-resistant clear coat is applied over the image using an airbrush or gantry-mounted sprayer. This clear coat provides additional protection against environmental factors such as ultraviolet light, rain, wind, and temperature fluctuations. Once the clear coat is cured, the masking material is removed, thereby revealing the completed image on the stone substrate.

In some embodiments, the system may include an exhaust or filtration system to extract fumes and particulates generated during laser operation. The computing device may further include a graphical user interface (GUI) to facilitate print setup, scaling, alignment, and system control.

The disclosed process is significantly faster and more energy-efficient than prior methods, reducing production time from days or weeks to a matter of hours, even for large-scale images. Perfect registration and alignment are achieved through the combined use of the laser and printer head on a common gantry system. The high-pressure air stream, also mounted on the same gantry, ensures optimal ink and colorant adhesion by maintaining a clean surface throughout the process.

System parameters may be saved within the computing device for various stone types, enabling repeatable and continuous operations while improving throughput. The process also reduces the need for volatile solvents and solvent-based pigments, lowering volatile organic compound (VOC) emissions by up to 95%. Power consumption is reduced by up to 90%, depending on image complexity, and the process eliminates the use of toxic materials, thereby creating a safer work environment for operators.

### DESCRIPTION OF THE DRAWINGS

The invention will be more readily understood from a reading of the following specification and by reference to the accompanying drawings forming a part thereof, wherein an example of the invention is shown and wherein:

FIG. 1 is an elevated perspective side and rear view of one embodiment of an automated stone imaging machine having a hood that is positioned on a gantry as a protective cover for a laser head for vitrifying a stone surface, a hose and nozzle assembly for blowing a high pressure air stream to clean the stone surface after laser vitrification thereof, a primary printer head for printing a white outdoor grade UV ink silhouette onto a stone surface, a secondary color head for printing color outdoor grade UV inks onto the white silhouette, and a UV light array for curing the inks;

FIG. 2 is an elevated perspective side and front view of one embodiment of an automated stone imaging machine that includes a computing device for electronically controlling a gantry that carries a laser head for vitrifying a stone surface, a hose and nozzle assembly for blowing a high pressure air stream to clean the stone surface after laser vitrification thereof, a primary printer head for printing a white outdoor grade UV ink silhouette onto a stone surface, a secondary color head for printing color outdoor grade UV inks onto the white silhouette, and a UV light array for curing the inks;

FIG. 3 is a magnified, partial view of one embodiment of an automated stone imaging machine that includes a computing device for electronically controlling a gantry that carries a laser head for vitrifying a stone surface, a hose and nozzle assembly for blowing a high pressure air stream to clean the stone surface after laser vitrification thereof, a primary printer head for printing a white outdoor grade UV ink silhouette onto a stone surface, a secondary color head for printing color outdoor grade UV inks onto the white silhouette, and a UV light array for curing the inks;

FIG. 4 is an elevated perspective view of one embodiment of an automated stone imaging machine including gantry that is slidably mounted to a square-profile linear rail system supported by four vertical legs, so that the rail system guides its movement with precision along the X-Y plane, and further illustrates a flexible cable drag chain configured to route and protect the power and signal cords as the gantry moves.

FIG. 5 is a magnified, elevated perspective view of one embodiment of an automated stone imaging machine that includes gantry that carries a laser head for vitrifying a stone surface, a hose and nozzle assembly for blowing a high pressure air stream to clean the stone surface after laser vitrification thereof, wherein the gantry is slidably mounted to a square-profile linear rail system supported by four vertical legs, so that the rail system guides its movement with precision along the X-Y plane, and further illustrates a flexible cable drag chain configured to route and protect the power and signal cords as the gantry moves;

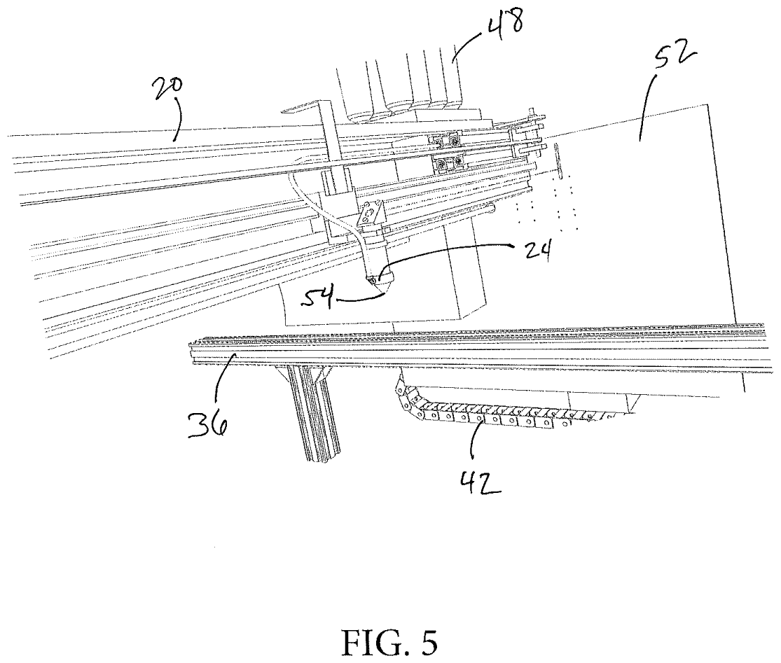

FIG. 6 is an elevated perspective view of one embodiment of an automated stone imaging machine including a gantry that is slidably mounted to a square-profile linear rail system supported by four vertical legs, so that the rail system guides its movement with precision along the X-Y plane. The figure further illustrates a flexible cable drag chain configured to route and protect the power and signal cords as the gantry moves. A raised platform is provided beneath the gantry for supporting stone substrates during processing. The figure also shows a pair of stone substrates positioned on the platform, with the gantry actively engaged over one of the substrates during an engraving and printing operation.

FIG. 7 is an elevated perspective view of one embodiment of an automated stone imaging machine including a gantry that is slidably mounted to a square-profile linear rail system supported by four vertical legs, so that the rail system guides its movement with precision along the X-Y plane. The figure further illustrates a flexible cable drag chain configured to route and protect the power and signal cords as the gantry moves. A raised platform is provided beneath the gantry for supporting stone substrates during processing. The figure also shows a pair of stone substrates positioned on the platform, with the gantry actively engaged over one of the substrates during an engraving and printing operation.

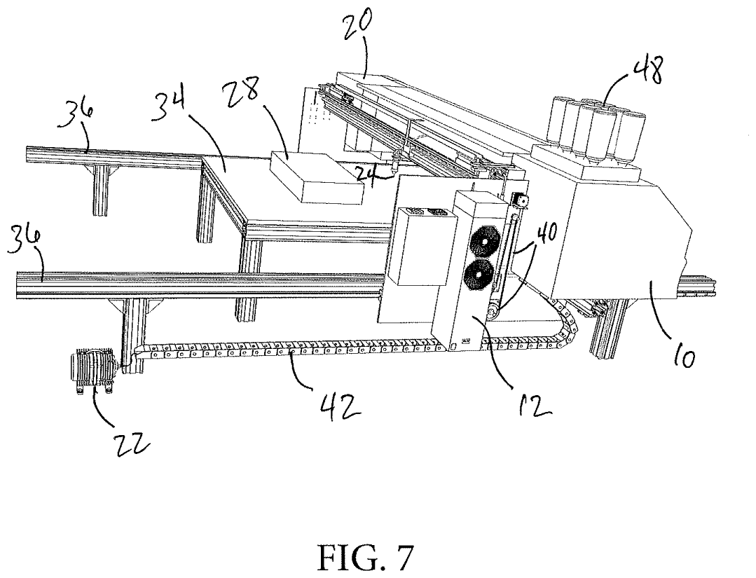

FIG. 8 is a side view of one embodiment of an automated stone imaging machine including a gantry that is slidably mounted to a square-profile linear rail system supported by four vertical legs, so that the rail system guides its movement with precision along the X-Y plane. The figure further illustrates a flexible cable drag chain configured to route and protect the power and signal cords as the gantry moves. A raised platform is provided beneath the gantry for supporting stone substrates during processing. The figure also shows a pair of stone substrates positioned on the platform, with the gantry actively engaged over one of the substrates during an engraving and printing operation.

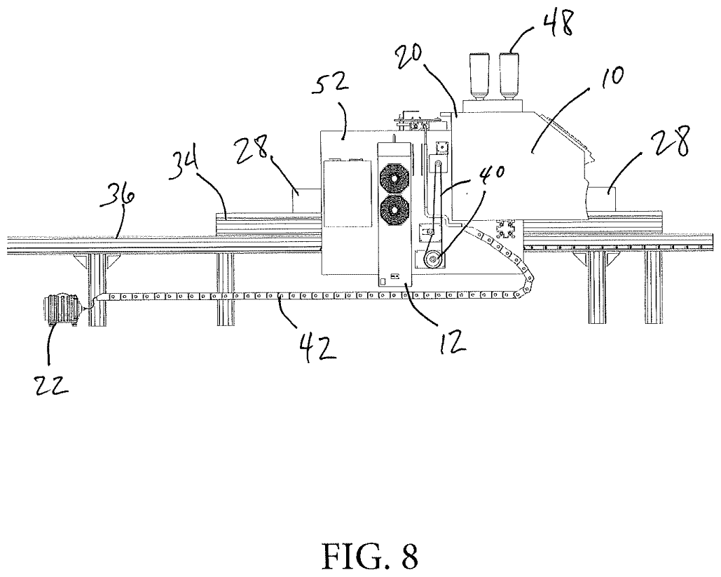

FIG. 9 is a top view of one embodiment of an automated stone imaging machine including a gantry that is slidably mounted to a square-profile linear rail system supported by four vertical legs, so that the rail system guides its movement with precision along the X-Y plane. The figure further illustrates a flexible cable drag chain configured to route and protect the power and signal cords as the gantry moves. A raised platform is provided beneath the gantry for supporting stone substrates during processing. The figure also shows a pair of stone substrates positioned on the platform, with the gantry actively engaged over one of the substrates during an engraving and printing operation.

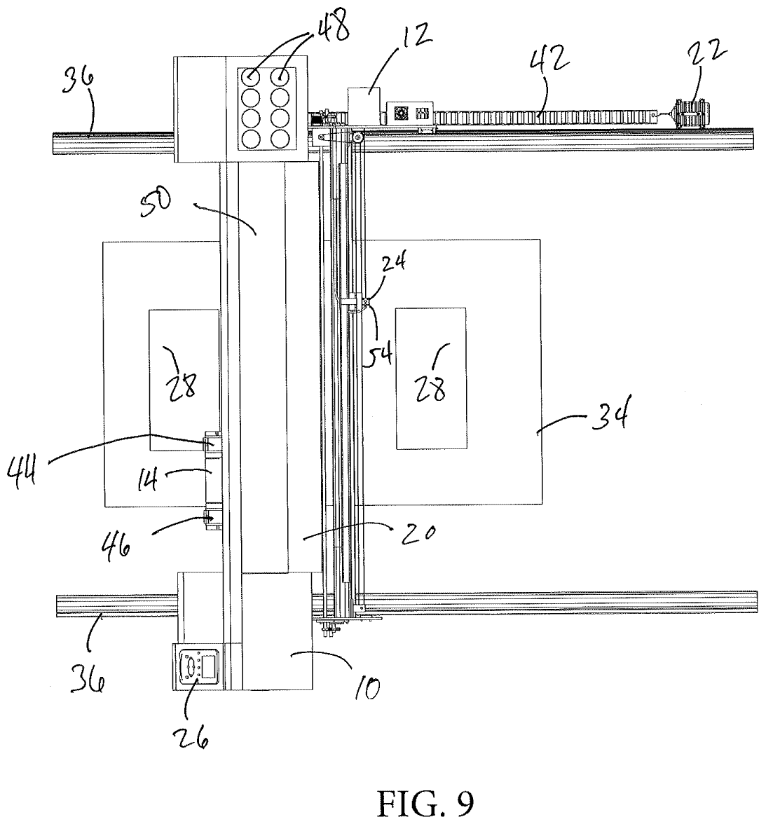

FIG. 10 is a rear view of one embodiment of an automated stone imaging machine including a gantry that is slidably mounted to a square-profile linear rail system supported by four vertical legs, so that the rail system guides its movement with precision along the X-Y plane. The figure further illustrates a flexible cable drag chain configured to route and protect the power and signal cords as the gantry moves. A raised platform is provided beneath the gantry for supporting stone substrates during processing. The figure also shows a pair of stone substrates positioned on the platform, with the gantry actively engaged over one of the substrates during an engraving and printing operation.

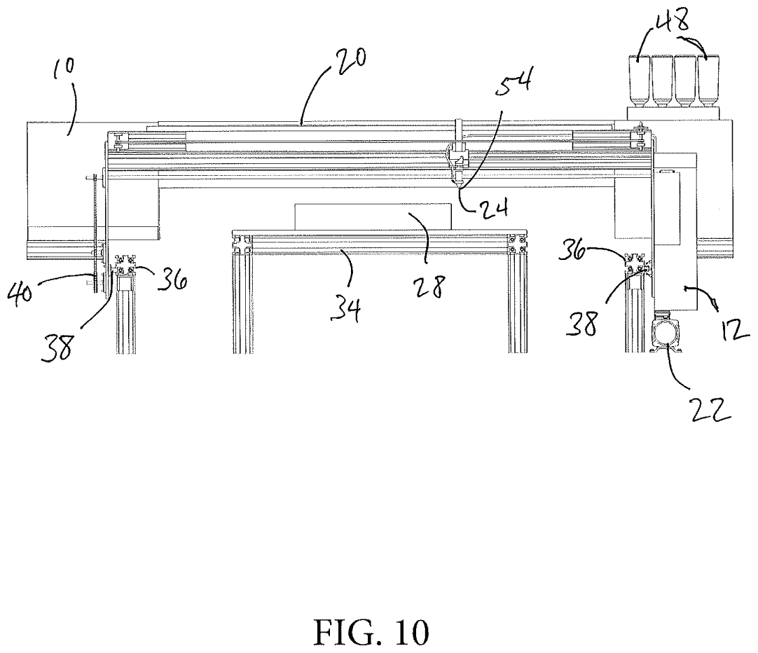

### DETAILED DESCRIPTION OF THE INVENTION

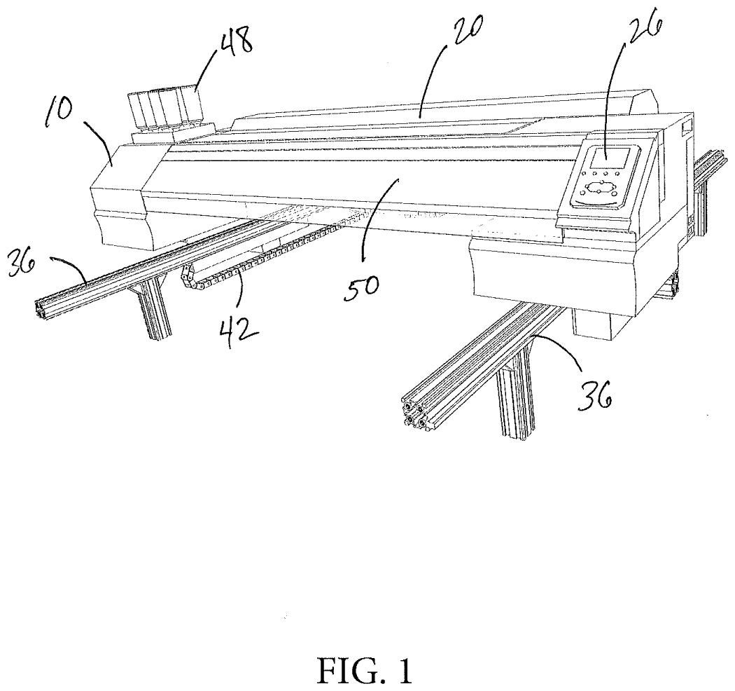

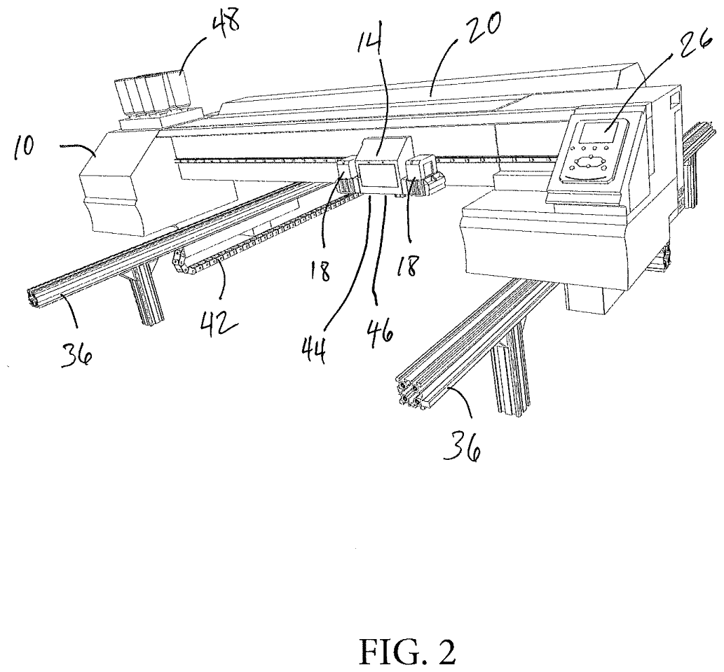

Referring now to the drawings, the invention will be described in more detail. As can best be seen in FIGS. 1-2, an automated stone imaging system is provided for engraving images on granite, marble, and synthetic stones, wherein an electronically guided laser 12 and wide-array UV printer head assembly 14 perform the vitrification and image application processes. The automated stone imaging system includes an integrated machine configured to generate a laser beam 12 of high-power output. In combination with a controlled method of steering both the laser 12 and the UV printer head assembly 14, the system permanently applies lettering and graphical images to the stone substrate 28, resulting in high-fidelity, high-resolution, and aesthetically pleasing visual outcomes.

The automated stone imaging system includes a housing 10, within which are mounted the following core components: a laser 12 capable of vitrifying the stone substrate 28; a UV wide-array printer head assembly 14; a computing device 16 or controller configured to coordinate the operation of the system; a UV light array 18; and a blower or air compressor 22 for delivering high-pressure air. These components are functionally attached to a mobile gantry 20, which moves in raster and/or vector patterns and supports the transport of the laser 12, printer head assembly 14, UV light array 18, and associated air-cleaning components including an air supply nozzle 24. The computing device 16 is operatively connected to each of these components and executes programmed instructions to carry out the imaging cycle on stone substrates 28 such as granite, marble, concrete, and other durable materials.

A digital control panel 26 may be located on a front portion of the housing 10. The control panel 26 is operatively connected to the computing device 16 and is used to input and execute commands associated with the various operational cycles, including vitrification, cleaning, printing, curing, and optional protective coating steps. The computing device 16 may take the form of an industrial PLC, embedded processor, or PC-based controller and may support storage and execution of multiple imaging routines and calibration profiles.

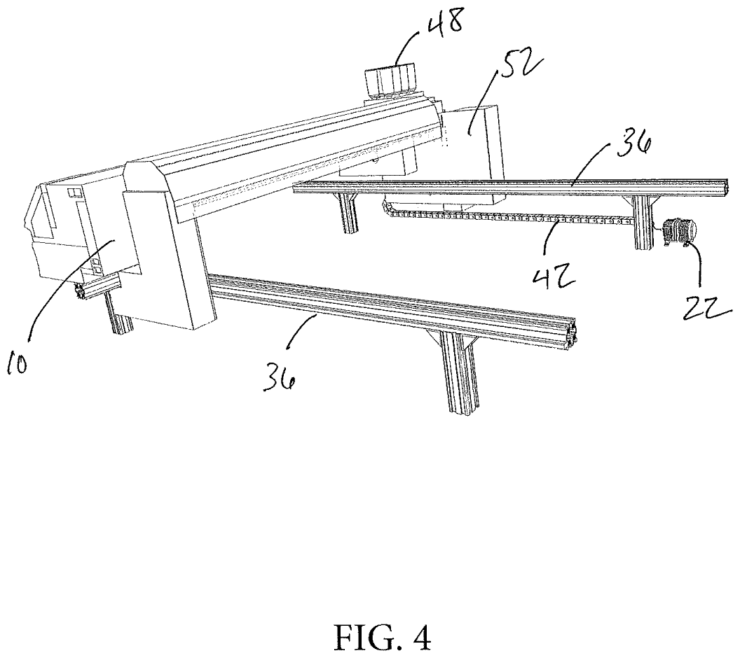

The laser 12, printer head assembly 14, UV light array 18, and air-cleaning components including the air supply nozzle 24 are supported on the gantry 20 that moves bidirectionally in the X-Y plane. The gantry 20 functions similarly to gantry systems used in large-format digital printers and ensures precise spatial coordination of all processing heads during each step of the engraving and printing process, as shown in FIG. 4.

In one embodiment, the gantry 20 includes a pair of vertically oriented common plates 52 mounted on opposite sides of the gantry structure. These common plates 52 provide structural support and serve as mounting surfaces for key subsystems. On the exterior side of one common plate 52, several components are affixed, including the laser 12 (also referred to herein as the laser emitter), a power supply or transformer for energizing the laser 12, and a set of gears and belts associated with the chain-and-sprocket drive mechanism 40 for moving the gantry 20 along the X-Y axes. Gears and belts are also positioned on the opposing common plate 52.

The laser 12 emits a laser beam along a horizontal channel formed on the underside of the gantry 20. As the beam travels through this channel, it reaches an angled mirror positioned near the center or distal end of the channel. The mirror redirects the laser beam downward to a focal lens within a laser lens assembly 54, which concentrates the beam into a highly focused dot for precise vitrification of the stone surface 28. The laser 12 further includes a pair of fans positioned to provide active ventilation and temperature control during operation, helping to maintain optimal laser performance and prevent overheating.

This optical configuration allows the laser 12 to remain stationary relative to the gantry 20 while enabling fine-point laser processing directly beneath the working area, as the laser beam is guided and focused downward by the lens assembly 54 that moves with precision across the substrate area.

In a preferred embodiment, movement of the gantry 20 along the X and Y axes is powered by one or more electric motors driving a chain and sprocket mechanism 40. The chain is affixed to the gantry 20 and routed along the frame, while a motorized sprocket engages the chain to translate the gantry smoothly and accurately along the rail system. This drive configuration provides reliable, repeatable motion control suitable for high-resolution imaging operations.

The gantry 20 is slidably attached to a linear guide rail system comprising one or more four-sided profile rails 36. Each side of the rail includes a recessed channel that receives a corresponding sliding member or bearing block 38 mounted to the gantry 20. This configuration enables the gantry 20 to travel linearly along the rail system with minimal friction and high precision. The guide rails 36 may be selected from commercially available square-profile linear guide rails, such as those manufactured by Hiwin or THK. In one embodiment, a brush 30 may also be mounted to the gantry 20 to aid in particulate removal during the cleaning cycle.

In certain embodiments, the gantry 20 or individual components mounted to it—such as the laser 12 or the UV printer head assembly 14—may be further adjustable along a Z-axis perpendicular to the stone substrate 28. Such Z-axis motion allows precise adjustment of focal distance, ink deposition height, or coating spray position. The Z-axis movement may be motorized and driven by a stepper motor, linear actuator, or lead screw mechanism under the control of the computing device 16. Optionally, the platform that supports and carries the stone substrate may be adjustable in the z-axis (upwardly and downwardly), either manually or via a powered motor, lifting and lowering mechanism, a scissor table, scissor lift, or the like.

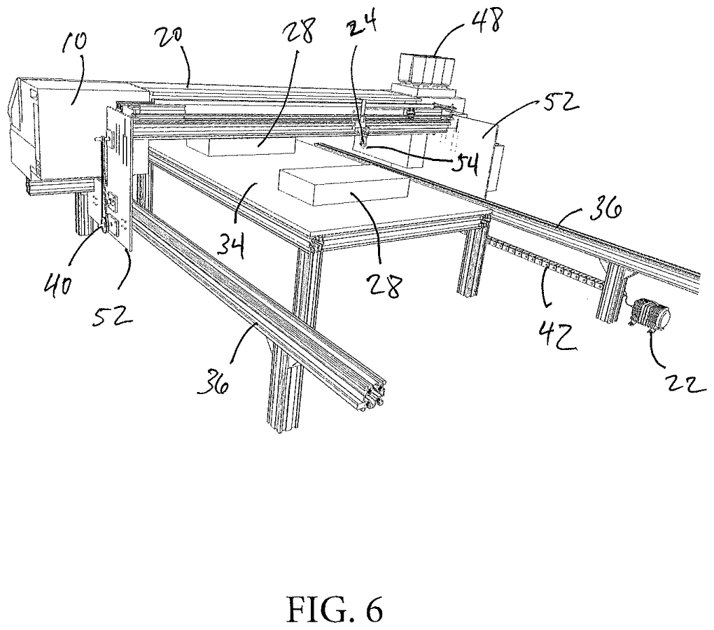

A power cord connected to the gantry 20 is routed through a flexible cable carrier 42, also known as a cable drag chain or energy chain. Other components may be carried by the cable drag chain, such as the air hose, controller cables, and the like. This drag chain 42, illustrated in FIGS. 4 and 6, resembles a segmented bicycle chain and is configured to flex and extend along the gantry's path of travel. The drag chain 42 retains and protects the power cord and any signal lines, preventing entanglement or wear as the gantry 20 moves along the linear guide rails 36. Suitable drag chains are available from manufacturers such as Igus or KabelSchlepp.

In one embodiment, a set of replaceable ink canisters 48 is mounted on an upper portion of the gantry 20. The ink canisters 48 are fluidly connected to the UV printer head assembly 14 and configured to supply white and color UV-curable inks to the primary print head 44 and secondary print head 46, respectively. The elevated position of the canisters 48 enables tool-free access for replacement, allowing operators to exchange depleted ink canisters without opening or removing any portion of the housing 10 or the gantry-mounted hood 50. The hood 50 functions as a protective cover surrounding the printer head assembly 14, laser 12, air nozzle 24, UV light array 18, and any additional components carried by the gantry 20, shielding them from dust and overspray during operation while permitting airflow and maintenance access as needed.

In one embodiment, the housing 10 may include an integrated exhaust system or vacuum port for removing smoke, fumes, and debris generated during laser vitrification. The exhaust system may be ducted externally or coupled with a HEPA or activated carbon filtration unit to maintain visibility, protect machine components, and ensure operator safety.

As shown in FIG. 6, a raised platform 34 is positioned beneath the gantry 20 and is configured to support one or more stone substrates 28 during the engraving and printing process. In the illustrated embodiment, the platform 34 supports a pair of stone substrates 28 arranged side by side, allowing the system to process multiple substrates in a single job run. The gantry 20 is shown positioned directly above one of the substrates during active operation, performing a coordinated sequence of laser vitrification, air cleaning, ink deposition, and UV curing. This configuration enables high-throughput processing and efficient batch production, as the computing device 16 may direct the gantry 20 to transition from one substrate to the next without manual repositioning or reloading, thereby improving workflow and reducing downtime.

### PROCESS OVERVIEW

### Preparation of the Stone

The stone substrate 28 is first loaded into the machine, masked, and aligned. An optimum focal point is established. In a preferred embodiment, outdoor-grade UV inks are applied to the stone substrate 28 via the UV printer head assembly 14. Because lighter stones have a tendency to absorb or stain, it is necessary to mask off the area designated for the image. A laser-compatible masking tape, such as 3-5 mil Mylar Laseredge™ tape, is applied to this region prior to laser processing.

A digital graphic file is loaded into the computing device 16. This file is converted into a machine-readable format capable of controlling both the laser 12 and UV printer head assembly 14. An origin point is established on the surface of the stone substrate 28, and the job is queued. The computing device 16 may adjust the imaging instructions based on predefined profiles related to the material properties of different stone types. It should be noted that the computing device and controller may be the same device or separate devices, and may be housed on the gantry, or remotely operated and operatively connected to the system.

### Vitrification

Next, the laser 12 is activated to selectively burn through the masking layer and vitrify the surface of the stone substrate 28 in a silhouette corresponding to the image area. This process creates a glassified surface, or “tooth,” to which the ink will adhere. In a preferred embodiment, the laser 12 passes twice over the designated image region to ensure full vitrification and to form a non-porous, moisture-resistant foundation. This vitrified layer prevents subsequent moisture migration and enhances image longevity.

The laser 12 operates at a power level of at least 60 watts and a feed rate of approximately 10 inches per second, although the specific parameters may vary depending on stone hardness and depth of vitrification required. In one embodiment, a 75-watt CO₂ laser available from Universal Laser is used, although other suitable laser types may be substituted.

The computing device 16 steers the laser beam 12 along a predefined path in raster and/or vector format. The masked stone substrate 28 is covered with a tape layer that vaporizes under the laser path, simultaneously forming a stencil while etching the stone. A black-and-white silhouette version of the input image is used to control laser firing locations and power settings, allowing the formation of detailed image contours.

While the system is optimized for use on natural stone substrates such as granite, marble, and concrete, it may also be used with engineered stones, ceramic tiles, porcelain, and other rigid materials capable of withstanding localized thermal and mechanical processing. The computing device 16 may store material-specific profiles to adjust laser power, feed rate, and print parameters accordingly.

Once vitrification is complete, the background area is cleaned using compressed air delivered by the blower or air compressor 22 through the air supply nozzle 24 and optionally the brush 30 mounted to the gantry 20. After this cleaning cycle, the UV printer head assembly 14 applies outdoor-grade UV ink to the prepared area in a preferred CMYK+ (cyan, cyan+, magenta, magenta+, yellow, black, white) format.

### Cleaning Cycle

Following laser vitrification, the gantry 20 returns to the origin position and executes a cleaning cycle by passing high-pressure air over the treated area. In one embodiment, the brush 30 is also passed over the image area to assist in removing debris. The system may perform multiple cleaning passes in either raster or vector mode. Air pressure is preferably in the range of 80-100 psi, supplied by the blower or air compressor 22 mounted within the housing 10 or externally connected. The air nozzle 24 follows the same gantry-guided movement as the laser 12 and printer head assembly 14, ensuring thorough coverage.

### Printing

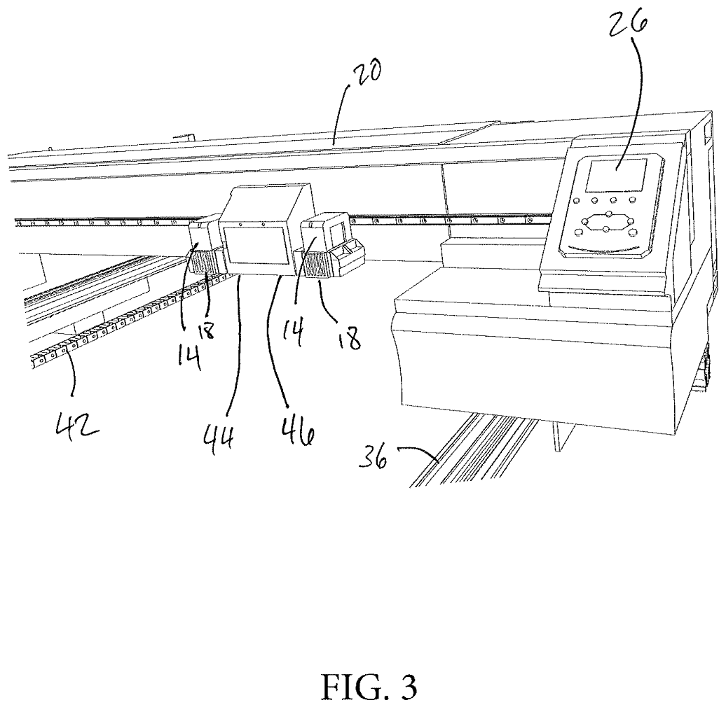

Once the surface is clean, the UV printer head assembly 14 begins the printing process. In one embodiment, as shown in FIGS. 2 and 3, the assembly includes a primary head 44 that deposits white UV-curable ink, followed by a secondary head 46 that applies color ink. The UV light array 18 then follows each pass to instantly harden the ink.

In one embodiment, the UV printer head assembly 14 may incorporate commercially available print heads such as those manufactured by Mimaki, including models suitable for outdoor-grade UV-curable inks, such as Model no. MLP 500-160, for example. The Mimaki print head is capable of high-resolution, full-color printing and may be adapted to apply white and color layers in a coordinated sequence as described herein. Other comparable UV printer heads may also be used without departing from the scope of the invention.

The initial white ink layer functions as a base for color enhancement and is applied directly to the vitrified silhouette. As the gantry 20 moves, the white ink is laid down, followed by the color layer and immediate exposure to UV light from the UV light array 18. This coordinated multi-pass operation results in full-color, high-resolution image reproduction. Color density and contrast may be adjusted by controlling the number of passes and the opacity of each ink layer.

Following color application, a clear UV-curable protective coating is applied. In one embodiment, a siloxane-based clear coat containing Tinuvin (a UV stabilizer manufactured by BASF) is deposited using an airbrush or similar device 32. Once cured, this layer significantly extends the image's resistance to weathering, UV exposure, and physical abrasion.

After coating, the laser 12 may be used again to outline the printed image and separate it from residual masking material. The laser 12 precisely cuts through the protective layers and masking boundary. This ensures a crisp separation between the printed image and surrounding substrate. Once this is complete, the remaining masking is peeled away to reveal the completed image. In certain embodiments, the protective coating may be applied using a nozzle or sprayer mounted on the gantry 20, thereby eliminating the need for masking altogether.

The system is capable of handling multiple stone substrates 28 in a single cycle. The computing device 16 can store multiple “home” or origin points, allowing batch processing of several stones within the same job run. This improves throughput and operational efficiency.

In summary, the automated stone imaging system described herein enables high-resolution, full-color image transfer to stone substrates 28 in a fully integrated, programmable, and efficient manner. The laser 12 vitrifies the surface to enhance adhesion, the UV printer head assembly 14 applies color with precise registration, and optional protective coatings are applied for outdoor durability. These functions are carried out automatically within a single machine footprint, offering significant improvements over traditional manual or semi-automated methods.

Although the present invention has been described in considerable detail with reference to certain preferred embodiments, it should be understood that various modifications, substitutions, and alterations may be made without departing from the spirit and scope of the invention as defined by the appended claims.

1. An automated stone imaging system for creating durable, high-resolution images on one or more stone substrates, comprising:
(a) a structural frame including a set of square-profile linear guide rails supported by vertical legs;
(b) a gantry assembly slidably mounted to the guide rails for movement along X and Y axes;
(c) one or more electric motors operatively coupled to the gantry assembly via a chain-and-sprocket drive mechanism for controlled linear movement;
(d) a laser mounted to the gantry, the laser being operable to vitrify a selected region of a stone substrate by melting a surface layer thereof;
(e) a UV printer head mounted to the gantry and configured to apply one or more UV-curable inks to the vitrified region;
(f) a UV light array mounted to the gantry and configured to cure the applied UV-curable inks;
(g) an air supply nozzle mounted to the gantry and configured to direct a high-pressure air stream onto the vitrified region to remove particulates;
(h) a flexible cable drag chain operatively connected to the gantry for managing power and signal cords during motion;
(i) a platform disposed beneath the gantry for supporting one or more stone substrates; and
(j) a computing device operatively connected to the laser, UV printer head, UV light array, air supply nozzle, and gantry motors, the computing device being configured to control each component in a coordinated sequence based on a digital image file to automatically form a high-resolution, multicolor image on the stone substrate.

2. The system of claim 1, wherein the guide rails comprise square-profile linear rails with recessed channels, and the gantry includes bearing blocks configured to slide within the channels.

3. The system of claim 1, wherein the laser is a CO₂ laser having an output power of at least 65 watts.

4. The system of claim 1, wherein the UV printer head includes a primary head for depositing white ink and a secondary head for depositing one or more colored inks.

5. The system of claim 1, wherein the gantry further includes a Z-axis adjustment mechanism operable to move one or more of the laser, printer head, or UV light array vertically relative to the stone substrate.

6. The system of claim 1, wherein the computing device is further configured to store process parameters corresponding to different types of stone substrates and automatically adjust imaging settings based on a selected substrate profile.

7. A method of producing a durable, high-resolution color image on a stone substrate using an automated imaging system, comprising:
(a) placing the stone substrate on a raised platform disposed beneath a gantry assembly;
(b) masking a region of the stone substrate with a laser-ablative masking material;
(c) moving the gantry into position above the masked region using a chain-and-sprocket drive mechanism;
(d) directing a laser mounted to the gantry to burn through the masking material and vitrify the exposed stone surface;
(e) cleaning the vitrified surface by directing a high-pressure air stream from a nozzle mounted to the gantry, optionally using a brush for particulate removal;
(f) applying a white UV-curable ink layer to the vitrified surface using a UV printer head mounted to the gantry;
(g) applying one or more colored UV-curable ink layers over the white layer using the UV printer head;
(h) curing the applied inks using a UV light array mounted to the gantry;
(i) applying a UV-resistant clear coat over the cured inks using a sprayer or airbrush; and
(j) removing any remaining masking material to reveal the completed image.

8. The method of claim 7, wherein the laser is operated at a power of at least 65 watts and a speed of approximately 10 inches per second.

9. The method of claim 7, wherein the UV inks are applied in a modified CMYK+ format comprising cyan, cyan+, magenta, magenta+, yellow, black, and white.

10. The method of claim 7, wherein the clear coat comprises a siloxane compound including a UV stabilizer.

11. The method of claim 7, wherein the computing device controls the coordinated movement of the gantry along X, Y, and Z axes.

12. The method of claim 7, further comprising processing multiple stone substrates sequentially on the platform without removing the prior substrate, wherein the computing device automatically shifts the gantry between substrates.

13. A system for applying a printed image to a hard substrate, comprising:
(a) a movable gantry;
(b) a laser mounted to the gantry and operable to alter a surface of the substrate;
(c) an inkjet or UV printer head mounted to the gantry and configured to apply ink to the altered surface;
(d) a controller operatively connected to the laser and the printer head, the controller configured to execute a digital image file to coordinate laser activation and ink application.

14. The system of claim 13, wherein the substrate comprises stone, ceramic, glass, or concrete.

15. The system of claim 13, further comprising a curing light source mounted to the gantry for hardening the applied ink.

16. The system of claim 13, wherein the laser is operable to vitrify or etch the surface of the substrate.

17. The system of claim 13, wherein the printer head is configured to deposit both a white base ink and one or more colored inks.

18. The system of claim 13, further comprising a platform beneath the gantry for supporting multiple substrates during a single job cycle.

19. The system of claim 13, further comprising an air nozzle mounted to the gantry for directing a high-pressure air stream across the substrate surface.

20. The system of claim 13, wherein the controller is configured to perform alignment of the printed image with the laser-altered region using stored calibration data.
